(19) United States
(12) Patent Application Publication
(10) Pub. No.: US 2024/0403608 A1
(43) Pub. Date: Dec. 5, 2024

(54) SYSTEM AND METHOD FOR CONSTRUCTING A MATHEMATICAL MODEL OF A SYSTEM IN AN ARTIFICIAL INTELLIGENCE ENVIRONMENT

(71) Applicant: Incucomm, Inc., Addison, TX (US)

(72) Inventor: Randal Allen, Orlando, FL (US)

(73) Assignee: Incucomm, Inc., Addison, TX (US)

(21) Appl. No.: 18/766,566

(22) Filed: Jul. 8, 2024

Related U.S. Application Data
(63) Continuation of application No. 16/674,942, filed on Nov. 5, 2019, now abandoned.
(60) Provisional application No. 62/756,044, filed on Nov. 5, 2018.

(51) Int. Cl. G06N 3/045; G06F 7/22; G06F 11/34; G06F 17/11; G06F 17/14; G06F 17/16; G06F 17/18; G06F 30/27; G06F 111/10; G06N 3/08; G06N 7/01; G06N 20/00

(52) U.S. Cl. CPC G06N 3/045; G06F 7/22; G06F 11/3452; G06F 17/11; G06F 17/16; G06F 17/18; G06F 30/27; G06N 3/08; G06N 7/01; G06N 20/00; G06F 17/142; G06F 2111/10

(57) ABSTRACT

A system and method for constructing an initial mathematical system representation with a combination of terms including mathematical functions with independent variables dependent on an input signal. A first set of known data is input to the initial mathematical representation to generate a output data. The output data of the initial mathematical representation and a second set of known data, correlated to the first set of known data, is fed to a comparator to generate error signals representing differences between output data and correlated members of the second set of known data. A parameter of the combination of terms is iteratively varied to produce a refined mathematical representation of the system until a measure of the error signals is reduced to a value wherein the output data of the refined mathematical representation over a desired range is equivalent to the second set of known data.

### CROSS-REFERENCE TO RELATED APPLICATION

This application claims the benefit of U.S. patent application Ser. No. 16/674,942 entitled “System and Method For Constructing A Mathematical Model Of A System In An Artificial Intelligence Environment” filed on Nov. 5, 2019 which claims the benefit of U.S. Provisional Patent Application No. 62/756,044, entitled “HYBRID AI,” filed Nov. 5, 2018, which is incorporated herein by reference.

This application is related to U.S. application Ser. No. 15/611,476 entitled “PREDICTIVE AND PRESCRIPTIVE ANALYTICS FOR SYSTEMS UNDER VARIABLE OPERATIONS,” filed Jun. 1, 2017, which issued on Oct. 6, 2020, as U.S. Pat. No. 10,795,337, which is incorporated herein by reference.

This application is related to U.S. Provisional Application No. 62/627,644 entitled “DIGITAL TWINS, PAIRS, AND PLURALITIES,” filed Feb. 7, 2018, converted to U.S. application Ser. No. 16/270,338 entitled “SYSTEM AND METHOD THAT CHARACTERIZES AN OBJECT EMPLOYING VIRTUAL REPRESENTATIONS THEREOF,” filed Feb. 7, 2019, which are incorporated herein by reference.

This application is related to U.S. application Ser. No. 16/674,848 (Attorney Docket No. INC-031A), entitled “SYSTEM AND METHOD FOR STATE ESTIMATION IN A NOISY MACHINE-LEARNING ENVIRONMENT,” filed Nov. 5, 2019, U.S. application Ser. No. 16/674,885 (Attorney Docket No. INC-031B), entitled “SYSTEM AND METHOD FOR ADAPTIVE OPTIMIZATION,” filed Nov. 5, 2019, and U.S. application Ser. No. 16/675,000 (Attorney Docket No. INC-031D, entitled “SYSTEM AND METHOD FOR VIGOROUS ARTIFICIAL INTELLIGENCE,” filed Nov. 5, 2019, which are incorporated herein by reference.

### RELATED REFERENCES

Each of the references cited below are incorporated herein by reference.

### Nonpatent Literature Documents

Sutton, R. S., and Barto, A. G., “Reinforcement Learning: An Introduction” (2018)
Kaplan A., and Haenlein, K., “Siri, Siri in my Hand, who's the Fairest in the Land?” (2018)
Chen, R. T. Q., Rubanova, Y., Bettencourt, J., and Duvenaud, D. “Neural Ordinary Differential Equations” (2018)
Jain, P, and Kar, P., “Non-Convex Optimization for Machine Learning” (2017)
Taleb, N., “The Black Swan—The Impact of the Highly Impossible” (2010)
Haken, H., “Information and Self-Organization” (2010)
Bazaraa, M, et al., “Nonlinear Programming: Theory and Algorithms” (2006)
Fouskakis, D., and Draper, D., “Stochastic Optimization: A Review” (2001)
Kelso, J. A. S., “The Self-Organization of Brain and Behavior” (1995)
Rumelhart, D. E., Hinton, G. E., and Williams, R. J., “Learning representations by back-propagating errors” (1986)

### TECHNICAL FIELD

The present disclosure is directed, in general, to artificial intelligence systems and, more specifically, to a system and method for constructing a mathematical model of a system in an artificial intelligence environment.

### BACKGROUND

Kaplan and Haenlein define Artificial Intelligence (AI) as “a system's ability to correctly interpret external data, to learn from such data, and to use those learnings to achieve specific goals and tasks through flexible adaptation.” AI dates to the mid-1950s with times of promise followed by disappointment and lack of funding. However, AI has seen a resurgence due to increased computational power, the ability to manipulate large amounts of data, and an influx of commercial research funding.

For the purposes of this disclosure, assume machine learning is a subset of AI (FIG. 1), with applications to image, speech, voice recognition, and natural language processing. In business applications, machine learning may be referred to in the context of predictive analytics. Unlike computer programs which execute a set of instructions, machine learning is based on models which learn from patterns in the input data. A major criticism of machine learning models is that they are black boxes without explanation for their reasoning.

There are three types of machine learning which depend on how the data is being manipulated. Supervised learning trains a model on known input and output data to predict future outputs. There are two subsets to supervised learning: regression techniques for continuous response prediction and classification techniques for discrete response prediction. Unsupervised learning uses clustering to identify patterns in the input data only. There are two subsets to unsupervised learning: hard clustering where each data point belongs to only one cluster and soft clustering where each data point can belong to more than one cluster. Reinforcement learning trains a model on successive iterations of decision-making, where rewards are accumulated because of the decisions. It will be apparent to those skilled in the art how this present invention is applicable to both deep reinforcement applications and to classic reinforcement, but with the superior form of networks described herein. A person having ordinary skill in the art will recognize there are many methods to solve these problems, each having their own set of implement requirements. Table 1 (below) shows a sampling of machine learning methods in the state of the art.

TABLE 1

| Regression | Classification | Soft Clustering | Hard Clustering |
|---|---|---|---|
| Ensemble methods | Decision trees | Fuzzy-C means | Hierarchical clustering |
| Gaussian process | Discriminant analysis | Gaussian mixture | K-means |
| General linear model | K-nearest neighbor | | K-medoids |
| Linear regression | Logistic regression | | Self-organizing maps |
| Nonlinear regression | naïve Bayes | | |
| Regression tree | Neural nets | | |
| Support vector machine | Support vector machine | | |

Current focus is on deep learning, a subset of machine learning (see FIG. 1). Applications include face, voice, and speech recognition and text translation which employ the classification form of supervised learning. Deep learning gets its name from the multitude of cascaded artificial neural networks. FIG. 2 shows a typical artificial neural network architecture used in machine learning. In its most basic form, the artificial neural network has an input layer, a hidden layer, and an output layer. For deep learning applications, the more layers, the deeper the learning. FIG. 3 shows a simplistic artificial neural network architecture used in deep learning where additional hidden layers have been added providing depth. In practice, deep learning networks may have tens of hidden layers. It will be apparent to those skilled in the art how the present invention is applicable to network constructs which are the equivalent of Multilayer Perceptrons (MLPs), Convolutional Neural Networks (CNNs), and Recurrent Neural Networks (RNNs) but with the advantages described herein.

As an example of the burden on the model designer, consider the application of supervised machine learning (classification) for object recognition or detection. The designer must manually select the relevant features to extract from the data, decide which classification method to use to train the model, and tune hyperparameters associated with fitting the data to the model. The designer does this for various combinations of features, classifiers, and hyperparameters until the best results are obtained.

In the case of deep learning, the manual step of selecting the relevant features to extract from the data is automated. However, to accomplish this, thousands of images are required for training and testing. Also, the designer is still responsible for determining the features. In the end, even highly experienced data scientists cannot tell whether a method will work without trying it. Selection depends on the size and type of the data, the insights sought, and how the results will be used.

While artificial neural networks are the basis for artificial intelligence, machine learning, and deep learning, there are problems associated with this technology. Significant issues include lack of transparency, depth of deep learning, under-fitting or over-fitting data, cleaning the data, and hidden-layer weight selection.

Because the artificial neural network was modeled after the human brain, it is difficult to see the connection between the inputs and outputs, which leads to a lack of transparency. The designer is often unable to explain why one architecture is used over another. This unknown opaqueness leaves the user wondering if the architecture can be trusted. For the designer, architectural selection becomes an exercise in numerical investigation. Architectural choices naturally include the number of inputs and outputs but becomes artificial when hidden layers and corresponding nodes are added. The number of hidden layers and the number of nodes comprise the depth of deep learning and is arbitrary. If you happen upon an architecture that appears to work, congratulations, but good luck explaining why to the user. Furthermore, architecture selection is based on the number of hidden layers and nodes: too few may lead to under-fitting, whereas too many may lead to over-fitting. In both cases, the overall performance and predictive capability may be compromised.

Other problems with artificial neural networks are the need to clean the data and, seemingly arbitrary, weight selection. Why should some data (outliers) be omitted from the training or test set? Maybe there is a plausible reason for the outlier's existence, and it should be kept because it represents reality. For instance, maybe the outlier represents what is known as a black swan—Nassim Taleb's metaphor for an improbable event with colossal consequences. The outlier should not be omitted simply to make the architecture more robust. Also, who is to say which weight factor should be placed on a hidden layer or set of nodes? Data cleansing and parameter tuning may lead to architectural fragility.

Upon surveying the prior art associated with machine learning in general, those skilled in the art will recognize the disadvantages of current methods. Refer again to FIG. 2 for a sampling of the state of the art, where each method has its own set of implementation requirements. In the case of supervised classification, the designer is required to manually select features, choose the classifier method, and tune the hyperparameters.

Deep learning brings with it its own set of demands. Enormous computing power through high performance graphics processing units (GPUs) is needed to process the data, lots of data. The number of data points required is on the order of 10⁵ to 10⁶. Also, the data must be numerically tagged. Plus, it takes a long time to train a model. In the end, because of the depth of complexity, it is impossible to understand how conclusions were reached.

The mathematical theory associated with artificial neural networks is the Universal Approximation Theorem (UAT)—which states a network, with a single hidden layer, can approximate a continuous function. Some practitioners rely on this too heavily and seem to ignore the assumptions associated with this approach. For example, as seen in FIG. 3, a relatively simple deep learning model has more than a single hidden layer. By implementing a deep learning model with multiple hidden layers, the UAT assumption is grossly violated. Also, for practical applications serving state of the art technologies, problem complexity surely increases. Once a model has been built, the architect may not be entirely sure the mathematical functions are continuous—another violation of UAT assumptions. While increasing the number of neurons may improve the functional approximation, any improvement is certainly offset by the curse of dimensionality. In other words, while additional neurons (for a single hidden layer) may improve the functional approximation, by increasing the number of hidden layers, the number of neurons compounds. Other version of the UAT come with their own limitations. In one version, linear outputs are assumed. In another version, convex continuous functions are assumed. The present invention can accept nonlinearities, nonconvexities, and discontinuities. One final (very relevant) comment: the UAT itself says nothing about the artificial neural network's ability to learn! With the present invention, the designer has complete control over what is being learned.

The artificial neural network architecture supporting machine/deep learning is supposedly inspired by the biologic nervous system. The model learns through a process called back propagation which is an iterative gradient method to reduce the error between the input and output data. But humans do not back-propagate when learning, so the analogy is weak in that regard. That aside, more significant issues are its black box nature and the designer having no influence over what is being learned.

Unsupervised learning is a form of machine learning used to explore data for patterns and/or groupings based on shared attributes. Typical unsupervised learning techniques include clustering (e.g., k-means) and dimensionality reduction (e.g., principal component analysis). The results of applying unsupervised learning could either stand-alone or be a reduced feature set for supervised learning classification/regression. However, these techniques also come with their limitations. With dimensionality reduction, principal component analysis requires the data to be scaled, assumes the data is orthogonal, and results in linear correlation. Nonnegative matrix factorization requires normalization of the data and factor analysis is subject to interpretation. Concerning clustering, some algorithms require the number of clusters to be selected a priori (e.g., k-means, k-medoid, and fuzzy c-means). Self-organizing maps implement artificial neural nets which come with their own disadvantages as cited above.

Therefore, a system is needed with an architecture where the designer has control over what is being learned and, thus, provides inherent elucidation. This architecture must be innovative and avoid the pitfalls of artificial neural networks with their arbitrary hidden layers, iterative feature and method selection, and hyperparameter tuning. The system must not require enormous computing power, it should quickly train and run on a laptop. Depending on the application, data tagging, while necessary, should be held to a minimum. Lastly, the system must not require thousands of (cleaned) data points. In the case of unsupervised learning, a system is needed where the number of clusters is not required a priori, data does not have to be labelled, and an artificial neural net model does not have to be trained.

### SUMMARY

Deficiencies of the prior art are generally solved or avoided, and technical advantages are generally achieved, by advantageous embodiments of the present disclosure of a system and method for constructing a mathematical model of a real system. The method includes constructing an initial mathematical representation of the system with a combination of terms, the terms comprising mathematical functions including independent variables dependent on an input signal. A first set of known data is inputted to the initial mathematical representation to generate a corresponding set of output data. The corresponding set of output data of the initial mathematical representation and a second set of known data, correlated to the first set of known data, is fed to a comparator, the comparator generating error signals representing a difference between members of the set of output data and correlated members of the second set of known data. A parameter of at least one of the combination of terms comprising the initial mathematical representation is iteratively varied to produce a refined mathematical representation of the system until a measure of the error signals is reduced to a value wherein the set of corresponding output data of the refined mathematical representation over a desired range is approximately equivalent to the second set of known data.

The foregoing has outlined rather broadly the features and technical advantages of the present disclosure in order that the detailed description of the disclosure that follows may be better understood. Additional features and advantages of the disclosure will be described hereinafter, which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, reference is now made to the following detailed description taken in conjunction with the accompanying drawings, in which:

FIG. 1 illustrates an artificial intelligence, machine learning, and deep learning hierarchy;

FIG. 2 illustrates an elementary artificial neural network model architecture;

FIG. 3 illustrates a simplistic artificial neural network model architecture for deep learning;

FIG. 4 illustrates a system architecture showing a mathematical model coupled to a subtractor;

FIG. 5 illustrates a generic mathematical model for input/output;

FIG. 6 illustrates a generic mathematical model for input/input;

FIG. 7 illustrates a mathematical model for system identification;

FIG. 8 illustrates a mathematical model for reinforcement learning;

FIG. 9 illustrates a mathematical model for Fourier series;

FIG. 10 illustrates a mathematical model for order finding;

FIG. 11 illustrates a Boolean circuit for classical logic;

FIG. 12 illustrates a mathematical model for a power series;

FIG. 13 (including FIGS. 13A and 13B) illustrates a mathematical model for clustering;

FIG. 14 illustrates a flow diagram of an embodiment of a method of constructing a mathematical model of a real system; and,

FIG. 15 illustrates a block diagram of an embodiment of an apparatus for constructing a mathematical model of a real system.

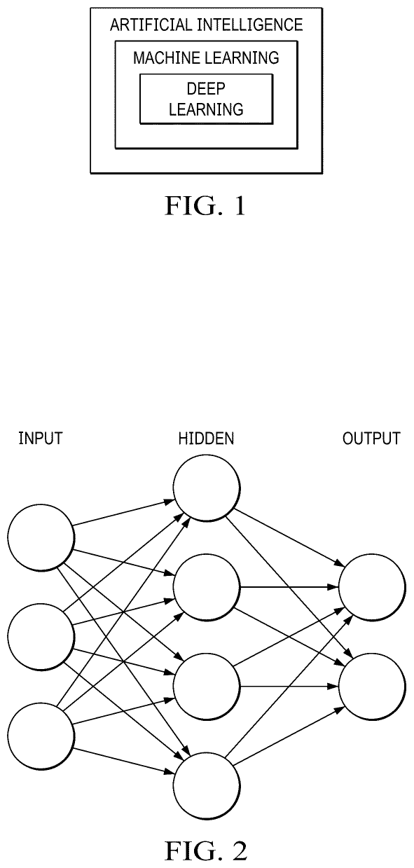

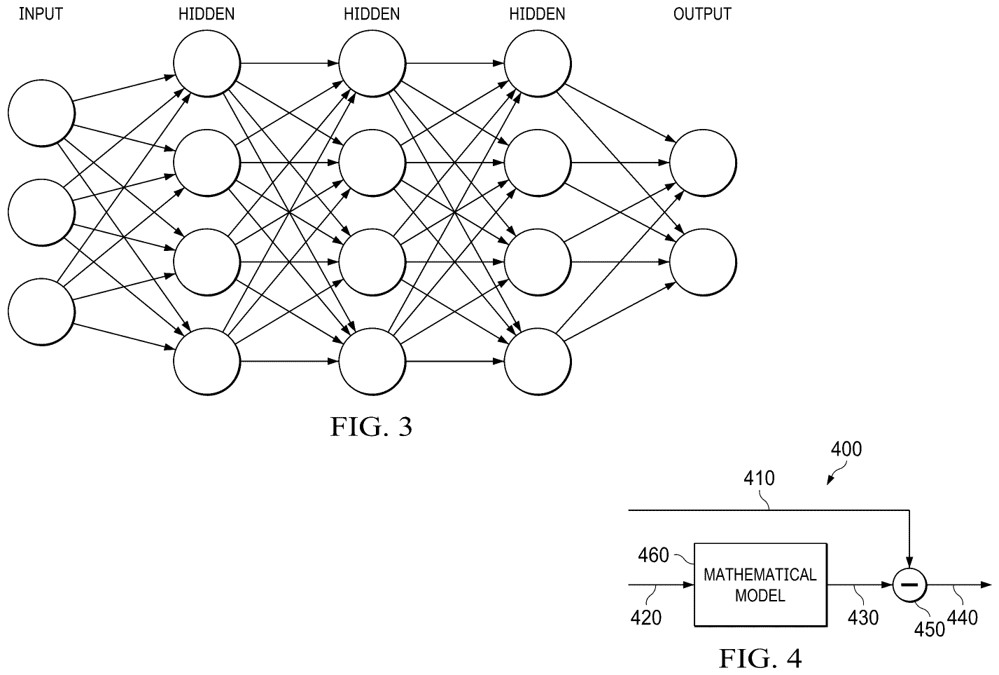

Corresponding numerals and symbols in the different figures generally refer to corresponding parts unless otherwise indicated and, in the interest of brevity, may not be described after the first instance.

### DETAILED DESCRIPTION

A unifying system architecture adaptable to a wide range of technological applications (e.g., machine, deep, and reinforcement learning; dynamic systems; cryptography; and quantum computation/information) is introduced herein. System architectures may contain nonlinearities, nonconvexities, and/or discontinuities. The designer has control over what is being learned and thus provides inherent elucidation of the results. This lends transparency and explanation to applications based on interpretable artificial neural networks. Furthermore, less data is needed to discover cause-effect relationships.

With limited success, artificial neural networks bring several disadvantages. The design process becomes an academic exercise in numerical investigation resulting in an untrusted “black box” where the designer has no influence over what is being learned. In the end, because of the depth of complexity, it is virtually impossible to understand how conclusions were reached.

A novel system architecture is introduced herein where the designer has control over what is being learned and thus provides inherent elucidation. This lends transparency and explanation to applications based on artificial neural networks. Embodiments include forms of artificial intelligence: machine, deep, and reinforcement learning; dynamic systems; cryptography; and quantum computation/information.

The making and using of the present exemplary embodiments are discussed in detail below. It should be appreciated, however, that the embodiments provide many applicable inventive concepts that can be embodied in a wide variety of specific contexts. The specific embodiments discussed are merely illustrative of specific ways to make and use the systems, subsystems, and modules for estimating the state of a system in a real-time, noisy measurement, machine-learning environment. While the principles will be described in the environment of a linear system in a real-time machine-learning environment, any environment such as a nonlinear system, or a non-real-time machine-learning environment, is well within the broad scope of the present disclosure.

Where the current state of the art creates a connection between two sets of data with a multitude of nodes, layers, and arbitrarily simple functions, the novel process introduced herein instead inserts a curated set of lucid mathematical functions between the two sets of data. This is a fundamental difference in that mathematical nonlinearities, and/or nonconvexities, and/or discontinuities can more quickly be approximated to reveal relationships between the two sets of data.

Referring to the system architecture (400) illustrated in FIG. 4, signal (420) is sent to the mathematical model (460) yielding output signal (430). The error signal (440), which is a difference between the feedforward signal (410) and the output signal (430), is minimized. The mathematical model (460) may be generic or specific, depending on the application. If available, one skilled in the art should incorporate a priori knowledge into the design of the mathematical model architecture. For example, if the problem is associated with mechanical vibration, then the mathematical model (460) should include Fourier sine and cosine terms. Minimization of the error signal (440) is achieved through optimization techniques. Through this process, signal (430) is forced to match signal (410) by adjusting parameters associated with the mathematical model (460).

This approach is unique in that it serves as a unifying system architecture among the many varied specialized sciences, including machine learning (Table 1). For example, in supervised learning (classification), output is related to input. Referring again to FIG. 4, an embodiment of the proposed invention solves this type of problem by simply connecting known input data to signal (420) and known output data to signal (410). In supervised learning (regression), output is related to output. An embodiment of the novel process solves this type of problem by simply connecting known output data to signal (420) and known output data to signal (410). For both supervised learning cases, parameters associated with the mathematical model (460) are varied until the computed result matches the known result. In the case of unsupervised learning (clustering), another embodiment of the proposed invention solves this type of problem by connecting the known input to both signal (410) and signal (420). By minimizing the error, signal (430) will match signal (410) and thus, characterize the input data based on the mathematical model (460). While various embodiments leverage the same system architecture, only the assignment of signal (410), signal (420), and the mathematical model architecture differ.

Any theory has two parts: a mathematical description and an interpretation of the mathematical formulas. Clearly, the model forms the mathematical description and because of an overt design, the transparent mathematical model is interpretable and explainable.

To understand how the system operates, consider an embodiment of the system architecture (400) where the designer has no a priori knowledge about the relationships of the data. In this case, assume the mathematical model contains generic mathematical functions such as a polynomial such as a second-order polynomial function, transcendental functions such as sine and cosine terms, exponential functions, and logarithmic functions. An example sum of terms is a₀+a₁x+a₂x²+ . . . +bₛ sin(nx)+b_{c} cos(nx)+c exp(nx)+d ln(nx). Other embodiments can involve different mathematical functions and operations, including classical Boolean/logic functions or quantum logic gates. To guard against such discontinuities that can be produced by logic functions, a novel optimization algorithm is employed which avoids partial derivatives and their associated numerical instabilities.

The coefficients a₀, a₁, a₂, bₛ, b_{c}, c, d are random variables between 0 and 1 and weighted such that they sum to 1. Because the system architecture is designed to minimize a differential error between some computed quantity and a known quantity, the coefficients are changed to place different weights on each of the mathematical function. Since the coefficients are random variables, their adaptation (over multiple Monte Carlo iterations) is probabilistic. All the statistics are available such that the designer can explore any set of coefficients for interesting (rare condition) cases. Nominally, however, the designer selects the median coefficient values which define a transparent, interpretable, and explainable relationship between the known input and the computed output. The system architecture is self-defined because the coefficients are determined empirically. There is no need for the designer to perform a numerical investigation of trial and error as in the case for artificial neural nets. The system architecture is transparent, interpretable, and explainable because the designer can show the mathematical function that relates known data to computed data.

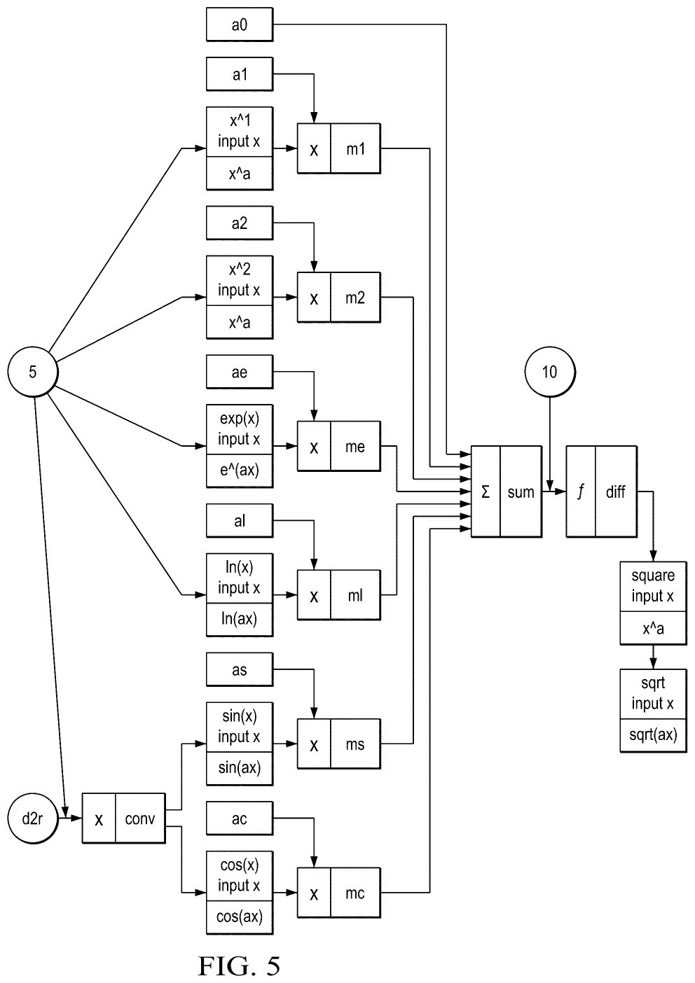

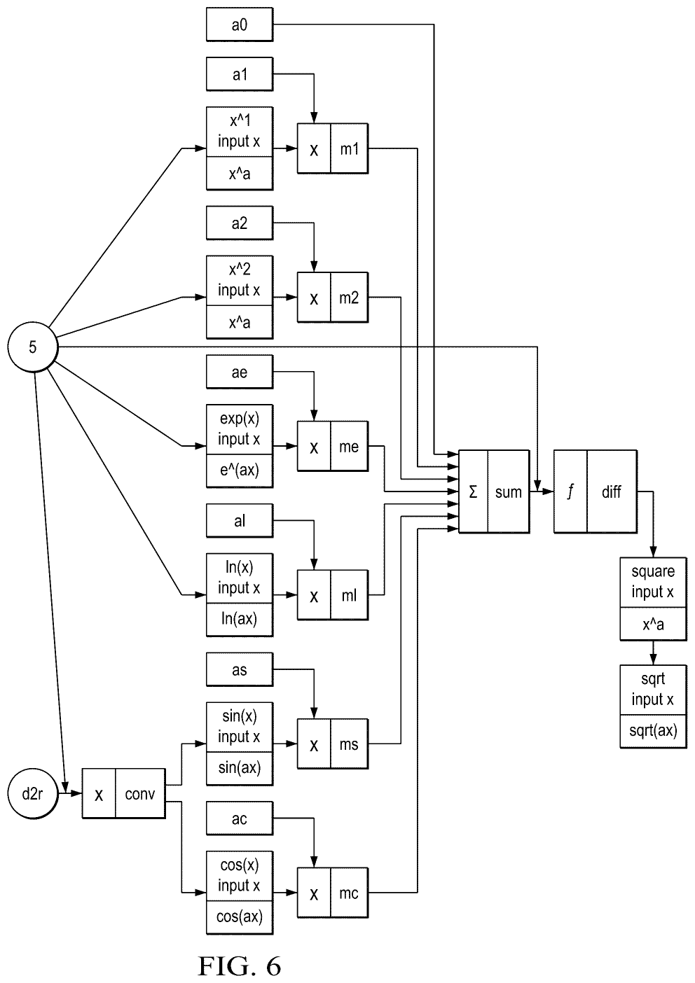

FIG. 5 refers to a generic mathematical model for input/output problems. Let the integer 5 be the known input (signal 420 of FIG. 4) and serve as the independent variable for a generic mathematical model a₀+a₁x+a₂x²+aₑ exp(nx)+aₗ ln(x)+aₛ sin(x)+a_{c} cos(x). Let the integer 10 be the known output (signal 410 of FIG. 4). Minimizing a difference between the computed output and the known output (signal 440 of FIG. 4) determines the coefficients a₀, a₁, a₂, aₑ, aₗ, aₛ, a_{c} of the mathematical functions. These coefficients describe the mathematical model and are used to explain the relationship between the input and output. FIG. 6 refers to a generic mathematical model for input/input problems and follows a similar approach as described in the preceding paragraph. However, these coefficients are used to explain the characteristics of the input. Both examples (input/output of FIG. 5 and input/input of FIG. 6) demonstrate the system architecture of the proposed invention supports a unified approach to supervised and unsupervised learning, respectively.

As a practical example, consider the process of system identification as applied to the estimation of the rolling moment aerodynamic parameter, Cₗ. One artificial neural net approach uses 5 independent variables to determine 3 dependent variables. After a preliminary exercise in numerical investigation (input/output scaling, initial network weights, number of hidden nodes, learning rate, momentum parameter, and slope factors of the sigmoidal activation functions) convergence is achieved after 2000 iterations. The result is a complex, opaque, uninterpretable, unexplainable relationship between the inputs and outputs. Also, if there are any changes to the inputs or outputs, the model must be retrained.

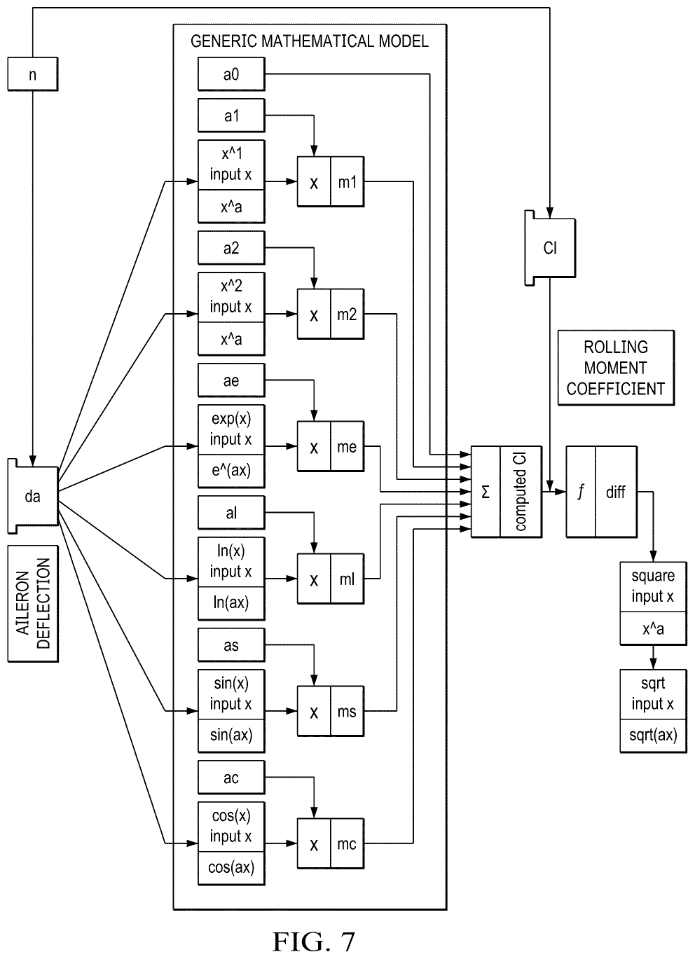

FIG. 7 refers to a mathematical model for system identification problems using the proposed invention. Let the aileron deflection be the known input (signal 420 of FIG. 4). Let the roll moment aerodynamic parameter be the known output (signal 410 of FIG. 4). One skilled in the art will recognize the direct relationship between aileron deflection and rolling moment aerodynamics. Minimizing a difference between the computed output and the known output (signal 440 of FIG. 4) determines the coefficients of the mathematical functions. Assuming the aerodynamic relationship between input and output is unknown, a generic mathematical model is used: a₀+a₁x+a₂x²+aₑ exp(nx)+aₗ ln(x)+aₛ sin(x)+a_{c} cos(x). The coefficients describe the model and are used to explain the relationship between the input (aileron deflection) and output (roll moment aerodynamic parameter). Rather than using an input/output ratio of 5:3, a 1:1 ratio is used with the proposed invention. Much less data is required to determine the relationship between the two data sets. Also, the results are achieved in 200 iterations—an order of magnitude less than required by the artificial neural net approach. Furthermore, the artificial neural net approach required the time series data to be in chronological order. The proposed invention is agnostic to any timestamp. The relationship between the two data sets is important, not the time at which they occur. While the model is still relatively complex, it is transparent, interpretable, and explainable. Because of these attributes, the proposed invention is much more reliable for flight safety certification. Finally, the mathematical model can be subsequently exercised to explore extreme cases, e.g., letting variables go to zero and letting variables approach infinity. Hence increasing confidence model deployment.

The designer has complete control over what is being learned using the novel process introduced herein. If the designer has a priori knowledge, mathematical or logical representations may or may not be included accordingly. The adaptive discovery of the proposed invention finds the best configuration of terms contributing to a scientific equation (based on a combination of elementary mathematical functions) which matches real-world observations. Because of mathematical transparency, the designer can easily interpret the results to see if they correspond with intuition and explain how the system works.

Back-propagation methods are replaced by an adaptive system for solving nonlinear, nonconvex problems. Paired with a rich set of options for mathematical functions, the system can be optimized for a training set of nearly any size. There are no restrictions on the problem space, including nonlinearities and/or discontinuities. In the case of multiple inputs/outputs, prior knowledge of the hyperspace is not needed. The mathematical architecture is independent of the input/output complexity. Inputs and outputs can be discrete, continuous, deterministic, random, or any combination thereof.

Regarding data, normalization may be performed to avoid domination by any one input. Otherwise, there is no need to manipulate the data. Furthermore, much less data is needed for the system identification architecture embodiment compared with the artificial neural net approach. This demonstrates no need for massive training sets.

There is also no need for enormous computing power. Every embodiment discussed in this specification runs on a laptop personal computer.

In the case of unsupervised learning (clustering), the number of clusters is not required to be known a priori, data does not have to be labelled, and an artificial neural net model does not have to be trained.

The novel process disclosed herein lends transparency and explanation to applications based on artificial neural networks. Benefits include, but are not limited to, minimizing risk associated with data security legislation, reducing reliance on large, clean data sets which otherwise limit practical applications, and reducing footprint for real-time applications dominating networks, servers, and GPUs.

The following embodiments are just a few examples and are discussed with intentions to demonstrate the flexibility of the system architecture as applicable to the problem space of current technologies, e.g., reinforcement learning, cryptography, information theory, and quantum computation/information. Those skilled in these arts will understand and appreciate their content.

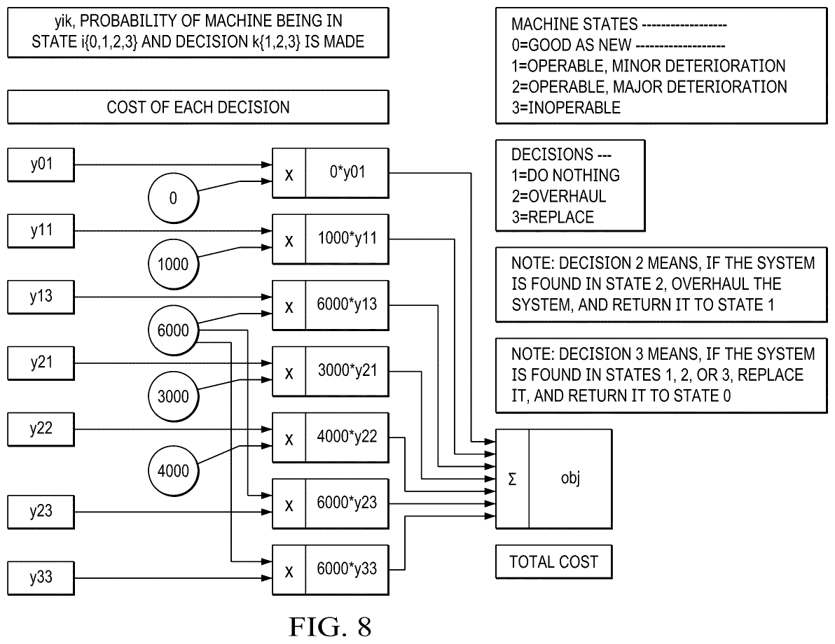

In one embodiment, the present invention can be used to emulate reinforcement learning. Reinforcement learning is the science of optimal decision-making. An agent, operating in an environment, is rewarded based on actions taken. The agent tries to figure out the optimal way to act within the environment. In mathematical terms, this is known as a Markov Decision Process (MDP). For this example, assume a manufacturer has a machine that is critical in the production process. The machine is evaluated each week to determine its operating condition. The state of the machine is either good as new, functioning with minor defects, functioning with major defects, or inoperable. Statistical data shows how the machine evolves over time. As the machine deteriorates, the manufacturer may select from the following options: do nothing, overhaul the machine, or replace the machine—all with corresponding immediate and subsequent costs. The manufacturer's objective is to select the optimal maintenance policy, as illustrated by the example shown in FIG. 8.

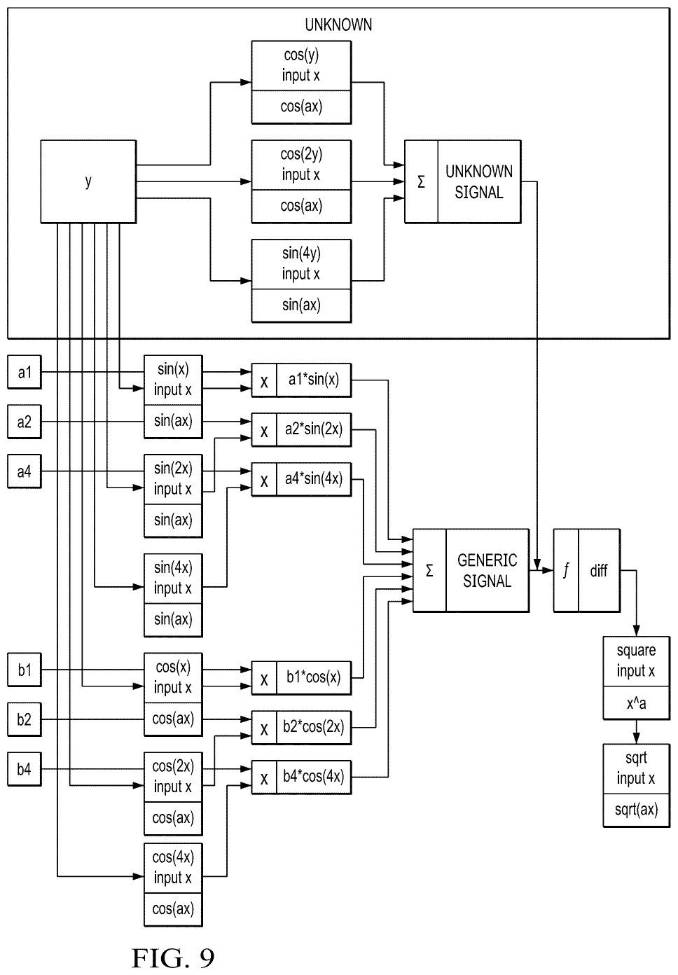

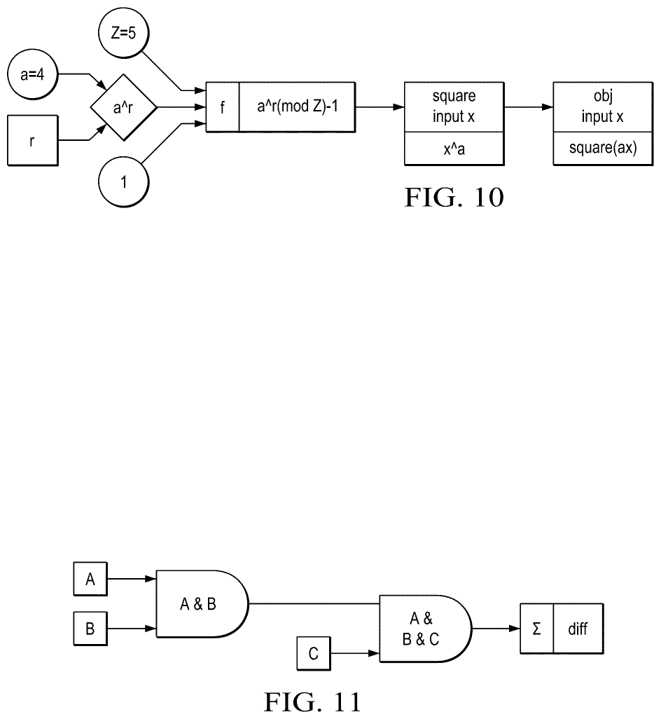

As another example, in one embodiment of the present invention (emulating cryptography) a sinusoidal signal, composed of a summation of many individual frequency components, is used as an input to a mathematical model of a discrete Fourier transform. By minimizing a difference between the computed signal and the reference signal, the reference signal is decomposed to determine its frequency content (FIG. 9). Continuing with another cryptography example, an embodiment of the present invention is used to perform the task of order finding (FIG. 10). Efficient order-finding can be used to break RSA public key cryptosystems. In this problem, the integer value of r is sought which satisfies the expression a^{r}≡1(mod N) where mod N means modulus N. In this example embodiment, the problem has been formulated as a^{r}(modN)−1, where a difference has been minimized over different integer values of r. Again, the same architectural approach is applied to a completely different problem type. Additional embodiments may be extended from Fourier transforms and cryptography to their quantum counterparts, i.e., quantum Fourier transforms and quantum cryptography.

Another example of an embodiment of the present invention (emulating Boolean logic) is a discontinuous classical circuit with three “AND” gates serving as the mathematical model (FIG. 11), i.e. A AND B AND C.

A truth table, Table 2, responsive to the binary inputs A, B, and C, showing the logical result A AND B AND C is illustrated below:

TABLE 2

| A | B | C | A&B&C |
|---|---|---|---|
| 0 | 0 | 0 | 0 |
| 0 | 0 | 1 | 0 |
| 0 | 1 | 0 | 0 |
| 0 | 1 | 1 | 0 |
| 1 | 0 | 0 | 0 |
| 1 | 0 | 1 | 0 |
| 1 | 1 | 0 | 0 |
| 1 | 1 | 1 | 1 |

Minimizing the output yields seven of the 2³=8 truth table values (0), while maximizing the output yields the final entry in a truth table, e.g., in Table 2. When maximizing this logic architecture, there is only one solution, i.e., A=B=C=1. Likewise, minimizing the architecture will yield all other results. This is significant because while some mathematical models may include many logic gates (e.g., decision-making) the complexity of the model architecture may render the problem intractable. Yet, the process introduced herein allows a practitioner to simply exercise the system to yield the corresponding truth table leading to the discovery of cause-effect relationships. Classical computation with Boolean circuits, using an acyclic directed graph, may be extended to another example embodiment of quantum computation/information by implementation of quantum circuits. These circuits form the basis for implementing various computations. While physicists and mathematicians view quantum computation as hypothetical experiments, computer scientists view quantum computation as games where players, typically Alice and Bob, optimize their performance in various abstractions. Applications include the minimization of bits for quantum error correction, and GHZ (Greenberger, Horne, and Zeilinger) and CHSH (Clauser, Horne, Shimony, and Holt) games.

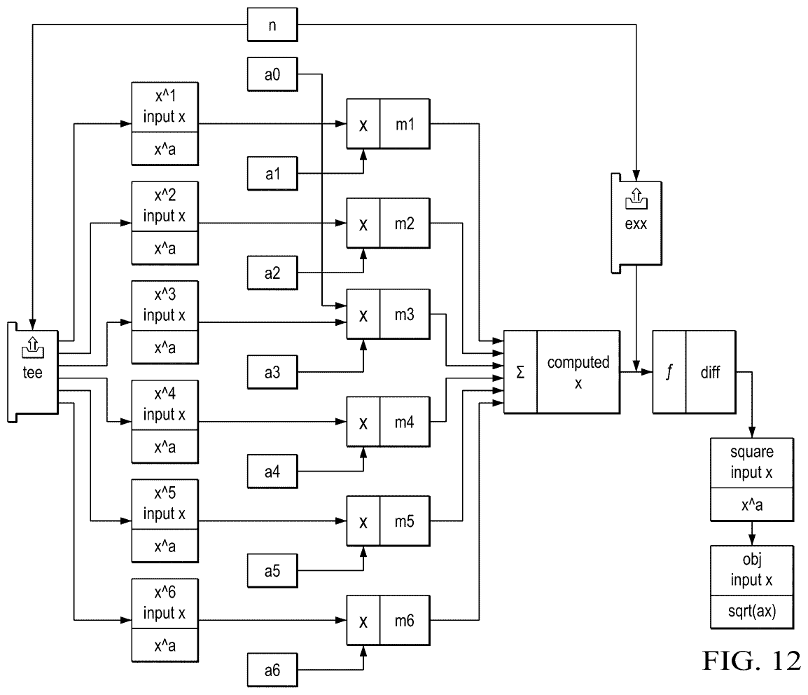

Another example of an embodiment of the present invention emulates information and self-organized complex systems. The human brain and behavior are shown to exhibit features of pattern-forming, dynamical systems, including multi-stability, abrupt phase changes, crises, and intermittency. How human beings perceive, intend, learn, control, and coordinate complex behaviors is understood through dynamic systems. Here, a dynamic system is modeled by a power series (Σₙaₙ^{x}) as a solution to an ordinary differential equation. A second-order harmonic oscillator (mass, spring, damper system) is used to create a set of input-output relations. Using the novel process introduced herein, the (spring and damping) coefficients are determined through the power series implementation of the differential equation (FIG. 12). Again, this demonstrates the flexibility of this unifying system architecture which is adaptable to a wide range of technological applications.

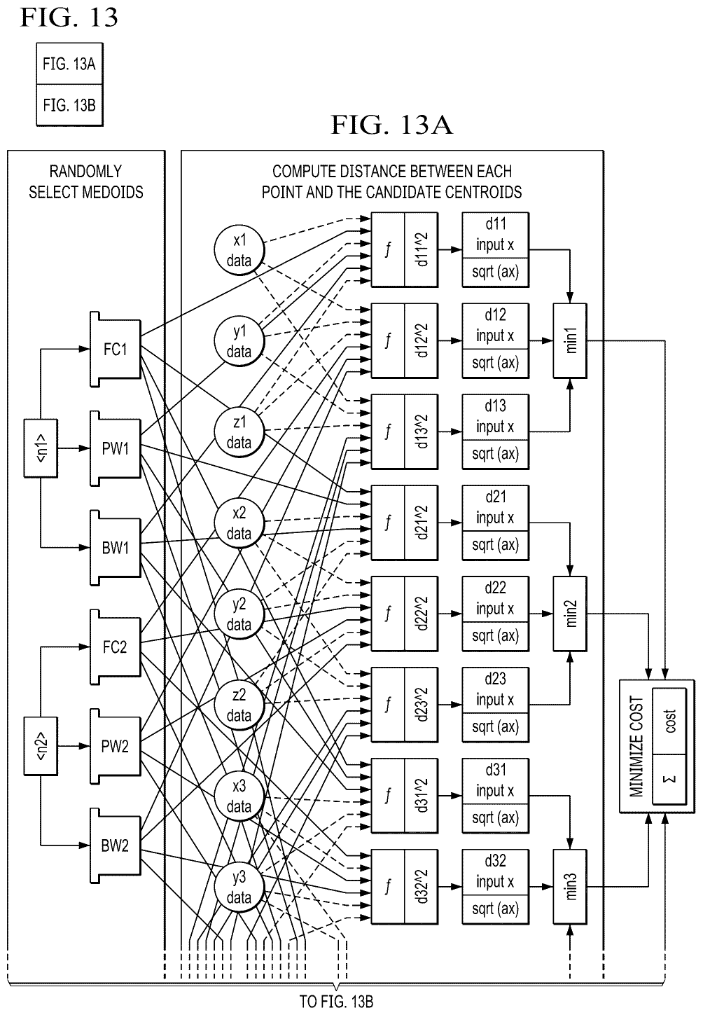

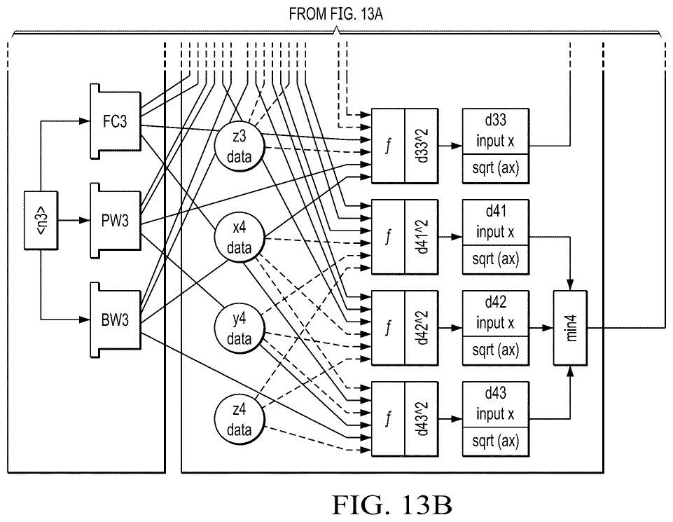

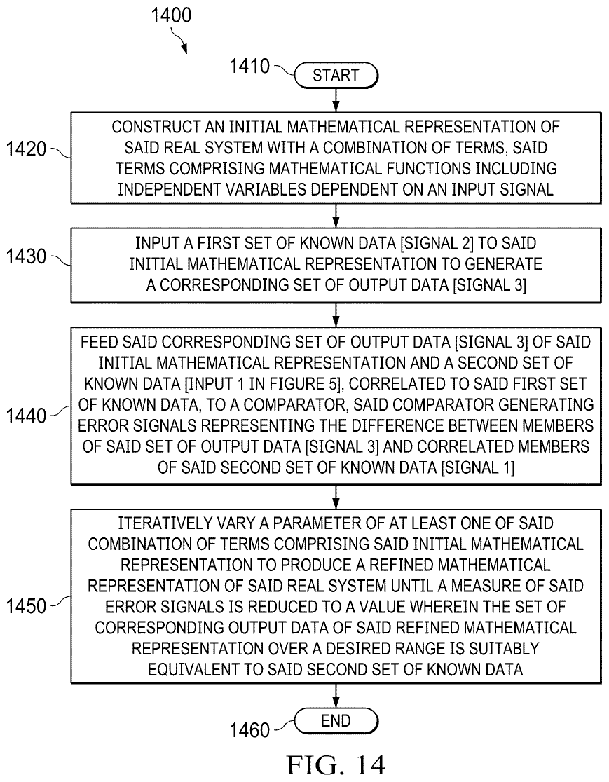

An example embodiment of the present invention applied to unsupervised learning is clustering (FIGS. 13A and 13B). This example combines the benefits of hard and soft clustering, i.e., the number of clusters does not need to be known, data may belong to more than one cluster, ellipsoidal clusters may have different sizes. Because data does not have to be labelled, dimensionality reduction techniques (e.g., Principal Component Analysis) are unnecessary and subsequently dismissed. Also, since the approach does not use artificial neural nets, a model does not need to be trained and thus, no training data is required. Furthermore, since the approach is stochastic, it allows for black swan clusters to be identified, if they exist.

The number of clusters, k, is determined automatically. After processing the data for a given cluster number, a histogram displays the number of data points assigned to each cluster. When the histogram is uniform, the data is over-fitted. Hence, the number of clusters (k) is one less than the current number. To identify the clusters, select k random points out of the n data points as medoids. Associate each data point with the nearest medoid by selecting the minimum distance. The sum of all minimums (for each data point) is the cost (objective function). Minimize (optimize) the cost to identify the clusters. Once the clusters have been identified, it is rudimentary to determine which data point is associated with each cluster. With the data clustered accordingly, it is a simple exercise to determine the centroid of the ellipsoidal cluster.

By avoiding deep learning techniques based upon artificial neural net architectures, all corresponding disadvantages (lack of transparency, lack of explainability, and the need to reserve training data and the time spent training the artificial neural net) are dismissed. Because data does not have to be cleaned or labelled, dimensionality reduction techniques (e.g., Principal Component Analysis) are unnecessary. Instead, statistical distributions of the data are applied. This approach does not rely on “stochastic gradient descent” (random guesses at partial derivatives) which can become numerically unstable with practical conditions. Alternatively, the objective function is evaluated directly using Monte Carlo techniques. The solution is scalable and may be implemented for real-time analysis.

To conclude, consider an example embodiment for real-time systems. As one skilled in the art is aware, real-time requirements for aerospace guidance, navigation, and control processes are different than real-time requirements for e-commerce transactions. However, in either case, the system may be augmented such that known constraints (if any) could be built into the objective function a priori. Also, by selecting an appropriate resolution, the system may be configured to execute in a deterministic time frame. This single approach for multifunctional systems may be used for industrial applications. These multifunctional systems must manage diverse objectives, multiple resources, and numerous constraints. A factory might use several types of power (e.g., pneumatic, electrical, and hydraulic), several types of labor skills, many different raw materials, all while making multiple products. A production optimization system based on the Industrial Internet of Things (IIoT) can collect data from thousands of sensors. A system with the computational efficiency to support real-time monitoring and control is a valuable advance in optimization techniques.

Again, the foregoing embodiments serve as examples across relevant technologies and are not meant to be exhaustive.

Turning now to FIG. 14, illustrated is a flow diagram of an embodiment of a method 1400 of constructing a mathematical model of a system that can be a real system. The method 1400 is operable on a processor such as a microprocessor coupled to a memory. The method 1400 begins at a start step or module 1410.

At a step or module 1420, an initial mathematical representation of the system is constructed with a combination of terms, the terms comprising mathematical functions including independent variables dependent on an input signal. The combination of terms includes at least one of a transcendental function, a polynomial function, and a Boolean function. A transcendental function can be a trigonometric function, a logarithmic function, an exponential function, or another analytic function.

At a step or module 1430, a first set of known data (corresponding to the signal 420 in FIG. 4) is inputted to the initial mathematical representation to generate a corresponding set of output data (corresponding to signal 430 in FIG. 4).

At a step or module 1440, the corresponding set of output data (corresponding to the signal 430 in FIG. 4) of the initial mathematical representation and a second set of known data (corresponding to the signal 410 in FIG. 4) correlated to the first set of known data, is fed to a comparator, the comparator generating error signals (corresponding to the signal 440 in FIG. 4) representing a difference between members of the set of output data (corresponding to the signal 430 in FIG. 4) and correlated members of the second set of known data (corresponding to the signal 410 in FIG. 4).

In one embodiment, the first set of known data and the second set of known data respectively comprise known input data and corresponding known output data for the real system; as such, this represents a supervised-classification learning mode. In another embodiment, the first set of known data and the second set of known data both comprise known output data for the real system; as such, this represents a supervised-regression learning mode. In a third embodiment, the first set of known data and the second set of known data both comprise known input data for the system; as such, this represents an unsupervised-clustering learning mode.

In an embodiment, the first set of known data and the second set of known data are a subset of all known data for the real system. As an example, the signal 420 illustrated in FIG. 4 can have multiple values. In a related embodiment, the subset of all known data is utilized to produce the refined mathematical representation of the real system and remaining data is utilized to test the refined mathematical representation for coherence over a fuller range of data.

At a step or module 1450, a parameter of at least one of the combination of terms comprising the initial mathematical representation is iteratively varied to produce a refined mathematical representation of the real system until a measure of the error signals is reduced to a value wherein the set of corresponding output data of the refined mathematical representation over a desired range is suitably equivalent to the second set of known data.

In an embodiment, the measure of the error signals corresponds to a maximum error signal for the first and second sets of known data. In an alternative embodiment, the measure of the error signals is a root-mean-square (RMS) value of the error signals.

In an embodiment, the step of iteratively varying a parameter of at least one of the combination of terms includes setting the coefficient of each term to a value between 0 and 1 such that all coefficients sum to 1. Setting the coefficient of each term to a value between 0 and 1 can be employed to normalize the terms.

The method 1400 terminates at end step or module 1460.

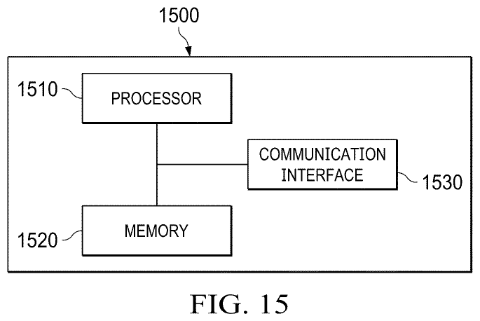

Turning now to FIG. 15, illustrated is a block diagram of an embodiment of an apparatus 1500 for-constructing a mathematical model of a system. The apparatus 1500 is configured to perform functions described hereinabove of constructing the mathematical model of the system. The apparatus 1500 includes a processor (or processing circuitry) 1510, a memory 1520 and a communication interface 1530 such as a graphical user interface.

The functionality of the apparatus 1500 may be provided by the processor 1510 executing instructions stored on a computer-readable medium, such as the memory 1520 shown in FIG. 15. Alternative embodiments of the apparatus 1500 may include additional components (such as the interfaces, devices and circuits) beyond those shown in FIG. 15 that may be responsible for providing certain aspects of the device's functionality, including any of the functionality to support the solution described herein.

The processor 1510 (or processors), which may be implemented with one or a plurality of processing devices, perform functions associated with its operation including, without limitation, performing the operations of constructing the mathematical model of the system. The processor 1510 may be of any type suitable to the local application environment, and may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as non-limiting examples.

The processor 1510 may include, without limitation, application processing circuitry. In some embodiments, the application processing circuitry may be on separate chipsets. In alternative embodiments, part or all of the application processing circuitry may be combined into one chipset, and other application circuitry may be on a separate chipset. In still alternative embodiments, part or all of the application processing circuitry may be on the same chipset, and other application processing circuitry may be on a separate chipset. In yet other alternative embodiments, part or all of the application processing circuitry may be combined in the same chipset.

The memory 1520 (or memories) may be one or more memories and of any type suitable to the local application environment, and may be implemented using any suitable volatile or nonvolatile data storage technology such as a semiconductor-based memory device, a magnetic memory device and system, an optical memory device and system, fixed memory and removable memory. The programs stored in the memory 1520 may include program instructions or computer program code that, when executed by an associated processor, enable the respective device 1500 to perform its intended tasks. Of course, the memory 1520 may form a data buffer for data transmitted to and from the same. Exemplary embodiments of the system, subsystems, and modules as described herein may be implemented, at least in part, by computer software executable by the processor 1510, or by hardware, or by combinations thereof.

The communication interface 1530 modulates information for transmission by the respective apparatus 1500 to another apparatus. The respective communication interface 1530 is also configured to receive information from another processor for further processing. The communication interface 1530 can support duplex operation for the respective other processor 1510.

As described above, the exemplary embodiments provide both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a processor. In particular, in the case of firmware or software, the exemplary embodiments can be provided as a computer program product including a computer readable storage medium embodying computer program code (i.e., software or firmware) thereon for execution by the computer processor. The computer readable storage medium may be non-transitory (e.g., magnetic disks; optical disks; read only memory; flash memory devices; phase-change memory) or transitory (e.g., electrical, optical, acoustical or other forms of propagated signals—such as carrier waves, infrared signals, digital signals, etc.). The coupling of a processor and other components is typically through one or more busses or bridges (also termed bus controllers). The storage device and signals carrying digital traffic respectively represent one or more non-transitory or transitory computer readable storage medium. Thus, the storage device of a given electronic device typically stores code and/or data for execution on the set of one or more processors of that electronic device such as a controller.

Thus, as introduced herein, the novel unified system architecture is adaptable to a wide range of technological applications. The unified system architecture is employed to construct a mathematical model of a system. The system architecture produces results that are transparent, interpretable, and can be used for explainable artificial intelligence. Control can be exercised over what is being learned by the model. The model may contain nonlinearities, nonconvexities, and discontinuities. Less data is needed for the model to discover cause-effect relationships.

Although the embodiments and its advantages have been described in detail, it should be understood that various changes, substitutions, and alterations can be made herein without departing from the spirit and scope thereof as defined by the appended claims. For example, many of the features and functions discussed above can be implemented in software, hardware, or firmware, or a combination thereof. Also, many of the features, functions, and steps of operating the same may be reordered, omitted, added, etc., and still fall within the broad scope of the various embodiments.

Moreover, the scope of the various embodiments is not intended to be limited to the embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized as well. Accordingly, the appended claims are intended to include within their scope such processes, machines, manufacture, compositions of matter, means, methods, or steps.

1. A method of operating a monitoring and control system, comprising:
controlling an operation of an industrial system utilizing a refined mathematical representation of said operation of said industrial system, comprising:
providing an initial mathematical representation of said industrial system including a combination of terms that include an independent variable that functionally models an expected operation of said industrial system;
receiving correlated first set of monitored data and second set of monitored data from sensors of said industrial system, said first set of monitored data including values for said independent variable;
inputting said first set of monitored data to said initial mathematical representation to generate model output data;
feeding said model output data and said second set of monitored data to a comparator that generates error signals representing a difference between members of said model output data and correlated members of said second set of monitored data; and
producing said refined mathematical representation by iteratively varying a parameter of at least one of said combination of terms until a measure of said error signals is reduced to a value such that said model output data over a desired range is approximately equivalent to said second set of monitored data, wherein iterations of varying said parameter are reduced to increase computational efficiency of said monitoring and control system to produce said refined mathematical representation to control said operation of said industrial system.

2. The method as recited in claim 1 wherein said sensors collectively sense data pertaining to use in said industrial system of different types of power, different labor skills, and/or different raw materials.

3. The method as recited in claim 1 wherein controlling said operation of said industrial system comprises utilizing said refined mathematical representation to optimize production of different products produced by said industrial system.

4. The method as recited in claim 1 wherein controlling said operation of said industrial system comprises utilizing said refined mathematical representation to predict non-optimal operation of a component of said industrial system.

5. The method as recited in claim 1 wherein said iteratively varying said parameter of said at least one of said combination of terms includes setting a coefficient of each of said combinations of terms to a value between 0 and 1 such that a sum of all coefficients equals 1.

6. The method as recited in claim 1 wherein said iterations are reduced by an order of magnitude compared to an artificial neural network approach.

7. The method as recited in claim 6 wherein said order of magnitude is ten.

8. The method as recited in claim 1 wherein said refined mathematical representation represents a state of a machine of said industrial system and an action based on said state to select an optimal maintenance policy for said machine.

9. The method as recited in claim 8 wherein said state includes that said machine is good-as-new, operable with minor deterioration, operable with major deterioration and inoperable, and said action to said machine includes do nothing, overhaul and replace.

10. The method as recited in claim 9, wherein:
if said state of said machine is operable with major deterioration and said action is overhaul said machine then return said state of said machine to operable with minor deterioration; and
if said state of said machine is operable with minor deterioration, operable with major deterioration or inoperable, and said action is replace said machine then return said state of said machine to good-as-new.

11. A monitoring and control system operable on a processor and memory, configured to:
control an operation of an industrial system utilizing a refined mathematical representation of said operation of said industrial system, configured to:
provide an initial mathematical representation of said industrial system including a combination of terms that include an independent variable that functionally models an expected operation of said industrial system;
receive correlated first set of monitored data and second set of monitored data from sensors of said industrial system, said first set of monitored data including values for said independent variable;
input said first set of monitored data to said initial mathematical representation to generate model output data;
feed said model output data and said second set of monitored data to a comparator that generates error signals representing a difference between members of said model output data and correlated members of said second set of monitored data; and
produce said refined mathematical representation by iteratively varying a parameter of at least one of said combination of terms until a measure of said error signals is reduced to a value such that said model output data over a desired range is approximately equivalent to said second set of monitored data, wherein iterations of varying said parameter are reduced to increase computational efficiency of said monitoring and control system to produce said refined mathematical representation to control said operation of said industrial system.

12. The monitoring and control system as recited in claim 11 wherein said sensors collectively sense data pertaining to use in said industrial system of different types of power, different labor skills, and/or different raw materials.

13. The monitoring and control system as recited in claim 11 wherein said control of said operation of said industrial system is configured to utilize said refined mathematical representation to optimize production of different products produced by said industrial system.

14. The monitoring and control system as recited in claim 11 wherein said control of said operation of said industrial system is configured to utilize said refined mathematical representation to predict non-optimal operation of a component of said industrial system.

15. The monitoring and control system as recited in claim 11 wherein said iteratively varying said parameter of said at least one of said combination of terms includes setting a coefficient of each of said combinations of terms to a value between 0 and 1 such that a sum of all coefficients equals 1.

16. The monitoring and control system as recited in claim 11 wherein said iterations are reduced by an order of magnitude compared to an artificial neural network approach.

17. The monitoring and control system as recited in claim 16 wherein said order of magnitude is ten.

18. The monitoring and control system as recited in claim 11 wherein said refined mathematical representation represents a state of a machine of said industrial system and an action based on said state to select an optimal maintenance policy for said machine.

19. The monitoring and control system as recited in claim 18 wherein said state includes that said machine is good-as-new, operable with minor deterioration, operable with major deterioration and inoperable, and said action to said machine includes do nothing, overhaul and replace.

19. The monitoring and control system as recited in claim 19, wherein:
if said state of said machine is operable with major deterioration and said action is overhaul said machine, then return said state of said machine to operable with minor deterioration; and
if said state of said machine is operable with minor deterioration, operable with major deterioration or inoperable, and said action is replace said machine, then return said state of said machine to good-as-new.
